(19) United States
(12) Patent Application Publication
(10) Pub. No.: US 2024/0309228 A1
(43) Pub. Date: Sep. 19, 2024

(54) METHOD OF REDUCING TACKINESS ON SURFACE WITH A COMPOSITION CONTAINING FUMED SILICA

(71) Applicant: Heritage Research Group, LLC, Indianapolis, IN (US)

(72) Inventors: Todd W. Thomas, Indianapolis, IN (US); Andrew Jacob Eicher, Carmel, IN (US)

(73) Assignee: Heritage Research Group, LLC, Indianapolis, IN (US)

(21) Appl. No.: 18/672,102

(22) Filed: May 23, 2024

Related U.S. Application Data
(63) Continuation of application No. PCT/US2022/051319, filed on Nov. 30, 2022.
(60) Provisional application No. 63/264,687, filed on Nov. 30, 2021.

(51) Int. Cl. C09D 7/61; C09D 7/45; C09D 7/65; C09D 129/04; C09D 195/00

(52) U.S. Cl. CPC C09D 7/61; C09D 7/45; C09D 7/65; C09D 129/04; C09D 195/00

(57) ABSTRACT

The present disclosure provides for compositions comprising fumed silica. In some embodiments, the compositions comprising fumed silica may be a polymer-containing emulsion. In some embodiments, these compositions can be applied to a bituminous material (e.g., asphalt binder) in an effort to limit tracking of the bituminous material. In some embodiments, the bituminous material comprises a tack coat. In some embodiments, the bituminous material comprises a joint sealant (e.g., a bottom-up longitudinal joint sealant).

### CROSS REFERENCE TO RELATED APPLICATION

This application is a continuation of International Application No. PCT/US2022/051319 filed Nov. 30, 2022, which claims the benefit of U.S. Provisional Patent Application No. 63/264,687 filed on Nov. 30, 2021, the disclosures of which are hereby incorporated herein by reference in their entireties.

### BACKGROUND

Tracking or tackiness of bituminous materials applied to the surface of a roadway (e.g., tack coats and joint sealants) may cause issues, for example, during the construction or repair of roads and other surfaces. Such materials can be picked up by the wheels/tracks of construction vehicles after application, even if such bituminous materials have been permitted to cure for a period of time. Therefore, there remains a need for improved compositions and methods that may be used, for example, during the construction or repair of roads or other surfaces.

### SUMMARY

In one embodiment, the present disclosure provides for a composition comprising fumed silica. In some embodiments, the composition comprising fumed silica may be a polymer-containing emulsion or colloidal suspension. In some embodiments, these compositions can be applied to a substrate, such as one comprising a bituminous material (e.g., asphalt binder-containing coatings), in an effort to limit tracking of the bituminous material. In some embodiments, the bituminous material comprises a tack coat. In some embodiments, the bituminous material comprises a joint sealant (e.g., a bottom-up longitudinal joint sealant).

In some embodiments, fumed silica may be modified. For example, in one embodiment, fumed silica may be treated with trimethylchlorosilane prior to being used in an emulsion or suspension. In one embodiment, the fumed silica used in compositions may comprise CAB-O-SIL® TS-610.

In some embodiments, fumed silica compositions may be prepared by combining fumed silica in water. In some one embodiments, fumed silica compositions may be prepared by combining fumed silica and a polymer in water. When used, a polymer may be water soluble in some embodiments.

In some embodiments, fumed silica compositions of the present disclosure may have an alkaline pH. In some embodiments, the pH of the fumed silica compositions may have a pH greater than 9, pH greater than 10, or pH greater than 11, such as about 12, about 13, or even about 14.

In further embodiments, fumed silica compositions may comprise a surface tension reducing surfactant. In some embodiments, a surface tension reducing surfactant may comprise a polymeric surfactant. In still other embodiments, a surface tension reducing surfactant may comprise an ethoxylate surfactant.

In some embodiments, tackiness may be reduced on a surface by selecting a surface and applying a composition comprising water and fumed silica to the surface. In some embodiments, the surface may be an asphalt surface, a surface comprising an asphalt tack coat, or a surface comprising an asphalt joint sealant. In some embodiments, when the surface comprises an asphalt joint sealant, the joint sealant may be a longitudinal joint sealant.

Additional embodiments of the invention, as well as features and advantages thereof, will be apparent from the descriptions herein.

### BRIEF DESCRIPTION OF THE DRAWINGS

FIG. 1 shows a graph of the pourable limit of compositions plotted by the weight of fumed silica (“wt/wt F.S.”) as a function of the pH of the starting sodium hydroxide solution.

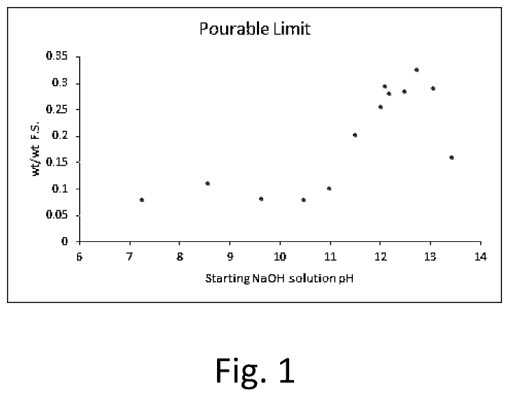

### DETAILED DESCRIPTION

For the purposes of promoting an understanding of the principles of the invention, reference will now be made to certain embodiments and specific language will be used to describe the same. It will nevertheless be understood that no limitation of the scope of the invention is thereby intended, such alterations and further modifications, and such further applications of the principles of the invention as described herein being contemplated as would normally occur to one skilled in the art to which the invention relates. Additionally, in the detailed description below, numerous alternatives are given for various features. It will be understood that each such disclosed alternative, or combinations of such alternatives, can be combined with the more generalized features discussed in the Summary above, or set forth in the embodiments described below to provide additional disclosed embodiments herein.

In some embodiments, fumed silica is generally hydrophobic, but nonetheless can have good compatibility with asphalt binders. Without being limited by theory, fumed silica compositions may be applied to the surface of an asphalt binder to help reduce or eliminate tracking from construction and motoring traffic immediately after hot application until it is covered with hot mix asphalt (“HMA”) at longitudinal joints or across the entire width of the road. Surprisingly, it has been found that after application of a HMA mat over the fumed silica-treated binder, the fumed silica is “absorbed” by the underlying asphalt binder and provides enhanced properties to the binder. For example, fumed silica may impart higher temperature stiffness to the underlying compositions. Additionally, dynamic shear rheometer tests show that addition of 1.5% to 2% by weight of fumed silica may raise the high temperature asphalt binder stiffness by 10° C., without adversely affecting the low temperature properties of the asphalt binder.

Although hot application of asphalt binder compositions disclosed herein have been found effective for joint treatments as well as in applications for reducing tracking in tack coat bonding application between lifts of hot mix asphalt, there is a desire to lower the temperature of application. In past, the asphalt industry has tried to address the temperature at which compositions are applied by asphalt emulsification with soap and water to produce a stable colloidal suspension. For example, some emulsified asphalt can be applied at 25-90° C. rather than 150-200° C. for hot asphalt applications such as spraying tack coats, applying chip seals and fog seals, and filling cracks in surfaces through a distributor with a hand wand.

However, to Applicant's knowledge, no one has previously described a suitable method for creating stable, pumpable aqueous compositions containing fumed silica so that they can be applied to the surface of a bituminous material via a spraying system without the need to heat the material. This is due to the hydrophobic nature of fumed silica. Without being bound by any particular theory, in one aspect, the present disclosure teaches the use of high pH systems and mixing (e.g., via circulation mixing, simple mixing, or shear mixing) to produce stable aqueous emulsions and suspensions comprising fumed silica.

More specifically, challenges with using fumed silica to make a stable colloidal suspension include the generally hydrophobic nature of fumed silica in water. Attempts to stabilize colloidal suspensions of fumed silica may result in rapid phase separation. Further, addition of fumed silica into an asphalt binder first, and then forming an emulsion has two challenges. First, added rheological stiffness of the asphalt binder and fumed silica mixture makes shearing more difficult in a colloid mill. Secondly, fumed silica is highly abrasive and may cause excessive wear in a colloid mill Further, attempts to post-add fumed silica into an asphalt emulsion with mixing has been found to lead to immediate phase separation of the asphalt emulsion and fumed silica.

Therefore, there is a need to find a way to (i) avoid the inclusion of excessive amounts of fumed silica into the initial asphalt binder emulsion (e.g., tack coat) and (ii) decrease the tackiness of the asphalt binder after application to the substrate.

In some aspects, the present disclosure seeks to provide improved compositions and methods of preparation of compositions comprising fumed silica that address such shortcomings. In some embodiments, this can be accomplished by (i) applying a fumed silica-containing emulsion or suspension to the surface of an asphalt binder, and (ii) permitting the application of an HMA mat over the fumed silica-coated asphalt binder, wherein the fumed silica is incorporated into the underlying asphalt binder.

In some embodiments, pH can be adjusted to overcome the hydrophobicity of fumed silica in water. Without being bound to a particularly theory, a high pH may be used to passivate the surface of fumed silica. For example, at a pH of 10 and higher a stable suspension was created with up to 30% fumed silica in water by weight using simple mixing with a mixing blade. In some embodiments, shear mixing (e.g., such as a lab blender) may be applied to provide a more stable suspension/solution. This white stable suspension can then be post added to any anionic emulsion or any nonionic or cationic slow set emulsion without destabilizing the emulsion whether through pH shift or silica sensitivity tests. The resulting colloidal mixture can then be applied like an asphalt emulsion through spray or wand applications. Testing on tack coat, chip seal and crack filling applications show that once the water is released the surface of the previously-applied tack coat now becomes non-tracking and having good high temperature stiffness.

In some embodiments, emulsions comprising fumed silica were prepared with and without a polymer. In some embodiments, a rapid, medium, and slow anionic emulsion was prepared. In further embodiments, a cationic or a nonionic slow setting emulsion was prepared.

In one embodiment, a composition with a pH of 12.5 was used as a starting solution by dissolving 1.6 g of NaOH per liter or 4.6 g NaOH per gallon. In some embodiments, the pH of the composition may have a pH of at least 9, a pH of at least 10, a pH of at least 11, or a pH of at least 12.5.

In some embodiments, a target 30% by weight suspension would utilize 596 g of TS-610 fumed silica per liter of base solution, or about 5 lbs. TS-610 fumed silica per gallon of base solution.

In some embodiments, fumed silica may be modified. For example, in one embodiment, fumed silica may be treated with trimethylchlorosilane prior to being used in an emulsion. In one embodiment, the fumed silica used in compositions may comprise CAB-O-SIL® TS-610.

Fumed silica may be suspended within water in composition of the present disclosure.

In some embodiments, fumed silica compositions may be prepared by combining fumed silica in water. In some embodiments, fumed silica compositions may be prepared by combining fumed silica and a polymer in water. When used, a polymer may be water soluble. When used, a polymer may comprise a polyvinyl alcohol polymer, a polyvinyl acetate polymer, an ethylene-vinyl acetate copolymer, a methyl cellulose polymer, or a polyethylene glycol polymer. In certain embodiments, when used, a polymer may comprise about 0.001 to about 5 wt. percent of the composition or from about 0.001 to about 2 wt. percent of the composition.

In some embodiments, fumed silica compositions of the present disclosure comprise an alkaline pH. In some embodiments, fumed silica compositions of the present disclosure may have an alkaline pH. In some embodiments, the pH of the fumed silica compositions may have a pH greater than 9, pH greater than 10, or pH greater than 11.

In further embodiments, fumed silica compositions may comprise a surface tension reducing surfactant. In one embodiments, a surface tension reducing surfactant may comprise a polymeric surfactant. In still other embodiments, a surface tension reducing surfactant may comprise an ethoxylate surfactant. When used, a composition may comprise about 0.001 to about 2 weight percent of a surface tension reducing surfactant.

In certain embodiments, the fumed silica may comprise about 0.001 to about 30 weight percent of the composition, about 0.01 to about 5 weight percent of the composition, or about 1 to about 5 weight percent of the composition.

In some embodiments, tackiness may be reduced on a surface by selecting a surface and applying a composition comprising water and fumed silica to the surface. In some embodiments, the surface may be an asphalt surface, a surface comprising an asphalt tack coat, or a surface comprising an asphalt joint sealant. In some embodiments, when the surface comprises an asphalt joint sealant, the joint sealant may be a longitudinal joint sealant.

In order to promote a further understanding of the present invention and its various embodiments, the following specific examples are provided. It will be understood that these examples are illustrative and not limiting of the invention.

### Example 1

### Preparation of Fumed Silica Composition

A composition of a 26% by weight solution of caustic was added to water in an IBC tote. The pH of the solution was about 14. Fumed silica was then added to provide a composition of about 17% total solids by weight. A pump was connected to an outlet of the IBC tote, and a hose was attached to the outlet of the pump placed in the top of the IBC tote for recirculation. A top-down tote mixer was placed in the total and the solution left to mix for about 12 hours to blend the fumed silica into the composition to provide a fumed silica composition.

### Example 2

### Preparation of Adhesion Promoter (“AP”) Composition

An AP composition was prepared targeting a 3% by weight solution of PVOH in water by adding PVOH powder to water under mixing in an IBC tote using an IBC tote mixer. The composition was warmed to above 200° F. for two hours while mixing using steam lines inserted into the composition. The composition was allowed to cool to ambient temperature.

### Example 3

### Preparation of Detackifier (“DT”) Composition

A detackifier composition was prepared by transferring 100 gallons of water and 0.75 gallons of an anionic surfactant to an empty IBC tote. 33 gallons of the fumed silica composition of Example 1 was added to the IBC tote with mixing. 67 gallons of the composition of Example 2 was added with mixing to provide a detackifier composition. Prior to use, the detackifier composition was mixed by mixer or agitation from a moving vehicle.

The uses of the terms “a” and “an” and “the” and similar references in the context of describing the invention (especially in the context of the following claims) are to be construed to cover both the singular and the plural unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the invention has been illustrated and described in detail in the drawings and the foregoing description, the same is to be considered as illustrative and not restrictive in character, it being understood that only some of the embodiments have been shown and described and that all changes and modifications that come within the spirit of the invention are desired to be protected. In addition, all references cited herein are indicative of the level of skill in the art and are hereby incorporated by reference herein in their entirety.

### Embodiments

The following provides an enumerated listing of some of the embodiments disclosed herein. It will be understood that this listing is non-limiting, and that individual features or combinations of features (e.g., 2, 3 or 4 features) as described in the Detailed Description above can be incorporated with the below-listed Embodiments to provide additional disclosed embodiments herein.
1. A method of reducing tackiness on surface, comprising:
   selecting a surface; and
   applying a composition comprising water and fumed silica to the surface.
2. The method of embodiment 1, wherein the surface comprises an asphalt surface.
3. The method of embodiment 2, wherein the surface comprises an asphalt tack coat or an asphalt joint sealant.
4. The method of embodiment 3, wherein the asphalt joint sealant comprises a longitudinal joint sealant.
5. The method of any one of embodiments 1-4, wherein the composition has a pH of at least 9.
6. The method of any one of embodiments 1-4, wherein the composition has a pH of at least 10.
7. The method of any one of embodiments 1-4, wherein the composition has a pH of at least 11.
8. The method of any one of embodiments 1-7, further comprising a surface tension reducing surfactant.
9. The method of embodiment 8, wherein the surface tension reducing surfactant comprises a polymeric surfactant.
10. The method of embodiment 9, wherein the surface tension reducing surfactant comprises an ethoxylate surfactant.
11. The method of any one of embodiments 1-10, wherein the fumed silica comprises about 0.001 to about 30 wt. % of the composition.
12 The method of embodiment 11, wherein the fumed silica comprises about 0.01 to about 15 wt % of the composition.
13. The method of embodiment 12, wherein the fumed silica comprises about 1 to about 5 wt. % of the composition.
14. The method of any one of embodiments 11-13, wherein the polymer comprises about 0.001 to about 5 wt. % of the composition.
15. The method of any one of embodiments 11-14, wherein the composition comprises about 0.001 to about 2 wt. % of a surface tension reducing surfactant.
16. The method of any of claims 1-15, further wherein the composition further comprises a polymer.
17. The method of embodiment 16, wherein the polymer is a polyvinyl alcohol, a polyvinyl acetate, an ethylene-vinyl acetate copolymer, a methyl cellulose, or a polyethylene glycol polymer.
18. The method of embodiments 16-17, wherein the polymer is water soluble.

1. A method of reducing tackiness on surface, comprising:
selecting a surface; and
applying a composition comprising water and fumed silica to the surface.

2. The method of claim 1, wherein the surface comprises an asphalt surface.

3. The method of claim 2, wherein the surface comprises an asphalt tack coat or an asphalt joint sealant.

4. The method of claim 3, wherein the asphalt joint sealant comprises a longitudinal joint sealant.

5. The method of claim 1, wherein the composition has a pH of at least 9.

6. The method of claim 1, wherein the composition has a pH of at least 10.

7. The method of claim 1, wherein the composition has a pH of at least 11.

8. The method of claim 1, further comprising a surface tension reducing surfactant.

9. The method of claim 8, wherein the surface tension reducing surfactant comprises a polymeric surfactant.

10. The method of claim 9, wherein the surface tension reducing surfactant comprises an ethoxylate surfactant.

11. The method of claim 1, wherein the fumed silica comprises about 0.001 to about 30 wt. % of the composition.

12. The method of claim 11, wherein the fumed silica comprises about 0.01 to about 15 wt % of the composition.

13. The method of claim 12, wherein the fumed silica comprises about 1 to about 5 wt. % of the composition.

14. The method of claim 11, wherein the polymer comprises about 0.001 to about 5 wt. % of the composition.

15. The method of claim 11, wherein the composition comprises about 0.001 to about 2 wt. % of a surface tension reducing surfactant.

16. The method of claim 1, further wherein the composition further comprises a polymer.

17. The method of claim 16, wherein the polymer is a polyvinyl alcohol, a polyvinyl acetate, an ethylene-vinyl acetate copolymer, a methyl cellulose, or a polyethylene glycol polymer.

18. The method of claim 16, wherein the polymer is water soluble.
